(19) United States
(12) Patent Application Publication
(10) Pub. No.: US 2010/0246605 A1
(43) Pub. Date: Sep. 30, 2010

(54) ENHANCED VISUAL EXPERIENCE FOR A PARTICIPANT IN A STREAMING EVENT

(75) Inventors: BRENT A. TAYLOR, ELGIN, IL (US); ROBERT T. CROSWELL, ELGIN, IL (US); GREGORY J. DUNN, ARLINGTON HEIGHTS, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 12/414,781

(22) Filed: Mar. 31, 2009

(51) Int. Cl. H04J 3/18

(52) U.S. Cl. 370/477

(57) ABSTRACT

A method of presenting content from a remote device is provided. Limited bandwidth content, transmitted from a remote device, is received at a local device. The limited bandwidth content is superimposed on enhanced content retrieved by the local device. The limited bandwidth content overlaps with the enhanced content such that the limited bandwidth content is a subset of what is represented by the enhanced content. The limited bandwidth or enhanced content may either be still images or video that is stitched together and displayed at the local device.

### TECHNICAL FIELD

The present invention relates generally to streaming content from a remote device to a local device. In particular, the invention relates to streaming limited bandwidth content from a remote device to a local device and combining the limited bandwidth content with enhanced content at the local device.

### BACKGROUND

Often times, content streamed from a remote device to a local device is streamed using a lower bandwidth and resolution than the local device is capable of accepting. As a result, the user is presented with an image or video which is significantly smaller than the local device is capable of displaying with acceptable resolution. The image or video transmitted may also suffer from a keyhole problem in that it consists of a smaller viewing angle instead of a more expansive panoramic view that may be available. Additionally, the remote device is often small and unstable, resulting in an image or video which is unstable and shaky.

As a result, it would be desirable to provide a user with content streamed from a remote device which suffers less from keyhole problems than current streamed content from remote devices. Additionally, it would be desirable to provide a user with content streamed from a remote device in which the image or video is more stable and less shaky than current streamed content from remote devices.

### SUMMARY

In one aspect, a method of presenting content from a remote device is provided. The method includes but is not limited to sending limited bandwidth content from a remote device to a local device and receiving the limited bandwidth content at the local device. The method also includes but is not limited to superimposing the limited bandwidth content on enhanced content retrieved by the local device. The limited bandwidth content comprises a subset of what is represented by the enhanced content.

In another aspect, a method of presenting content is provided. The method includes but is not limited to receiving at a local device limited bandwidth content streamed from a remote device and retrieving at the local device enhanced content. The method also includes but is not limited to forming a combined image having the limited bandwidth content continuously superimposed on the enhanced content. The limited bandwidth content comprises a subset of what is represented by the enhanced content.

In another aspect, a method of presenting content from a remote device is provided. The method includes but is not limited to streaming limited bandwidth content captured at a remote location from a remote device to a local device. The method also includes but is not limited to aligning the limited bandwidth content with the enhanced content retrieved by the local device. The limited bandwidth content comprises a subset of what is represented by the enhanced content. The limited bandwidth content includes a first visual cue. The enhanced visual content includes a second visual cue. The first and second visual cues represent the same object. The first and second visual cues are aligned with each other.

The scope of the present invention is defined solely by the appended claims and is not affected by the statements within this summary.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 depicts a block schematic diagram of an exemplary computing system, in accordance with one embodiment of the present invention.

FIG. 2 depicts a schematic representation of a remote device capturing limited bandwidth content at a scene of a remote location, in accordance with one embodiment of the present invention.

FIG. 3 depicts a schematic representation of an enhanced content being combined with limited bandwidth content, to form a combined image, in accordance with one embodiment of the present invention.

FIG. 4 depicts a schematic representation of a local device displaying a combined image, in accordance with one embodiment of the present invention.

FIGS. 5, 6, and 7 depict various combined images having video and still images, in accordance with one embodiment of the present invention.

FIG. 8 depicts a flowchart illustration of methods, apparatus (systems) and computer program products, in accordance with one embodiment of the present invention.

### DETAILED DESCRIPTION

The present method combines limited content streamed from a remote device with enhanced content retrieved by a local device to form a combined content that has portions of the limited content overlaid on the enhanced content. As a result, at least a portion of the combined content provides the user with a more current and possibly more detailed view of a scene, using the limited content. Additionally, a remaining portion of the combined content provides the user with more information about the scene than can be provided by just the limited content, providing a larger context for the limited content and helping eliminate the keyhole viewing and image stability problems associated with displaying just the limited content. This results in the user being provided with a scene (or a facsimile of a scene) in which the user may be interested without using a large amount of bandwidth or time to provide only aspects of the scene. It also reduces the amount of power used by the remote device in transmitting and/or processing, e.g., an image captured by the remote device and provided to the local device.

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

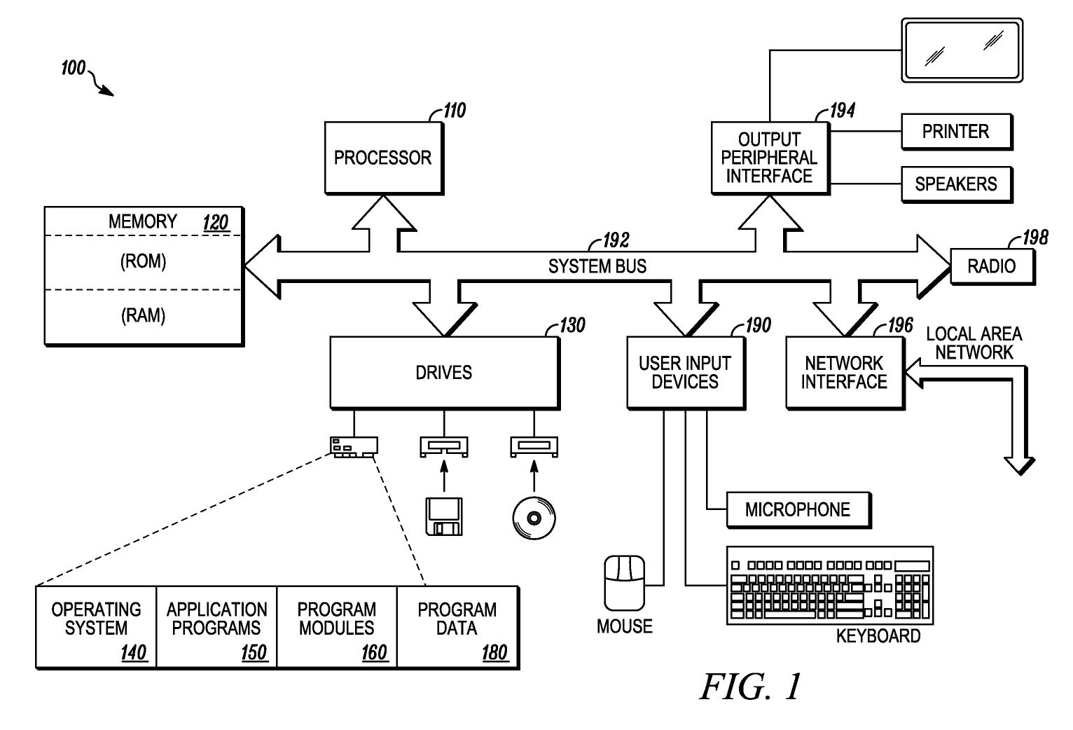

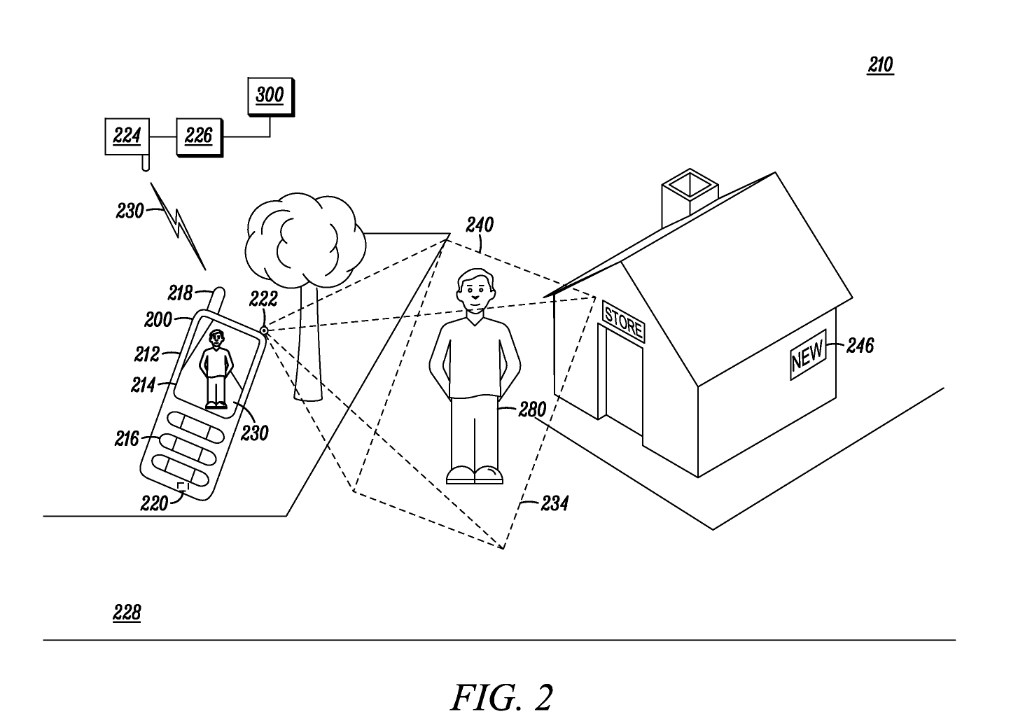

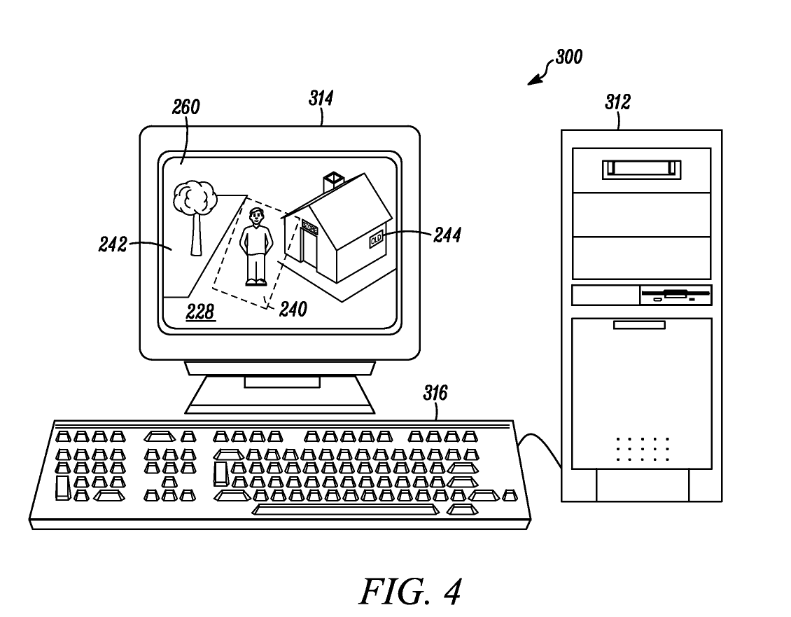

With reference to FIG. 1, depicted is an exemplary computing system for implementing embodiments. FIG. 1 includes a computer 100, which could be any one of a remote device 200 (shown in, e.g., FIG. 2) or local device 300 (shown in, e.g., FIG. 4). Computer 100 may be a portable device, wherein at least some or all of its components are formed together in a single device which can be carried around by a person. The computer 100 includes a processor 110, memory 120 and one or more drives 130. The drives 130 and their associated computer storage media provide storage of computer readable instructions, data structures, program modules and other data for the computer 100. Drives 130 can include an operating system 140, application programs 150, program modules 160, and program data 180. Computer 100 further includes input devices 190 through which data may enter the computer 100, either automatically or by a user who enters commands and data. Input devices 190 can include an electronic digitizer, a microphone, a camera, a video camera, a keyboard and a pointing device, commonly referred to as a mouse, trackball, joystick, or touch pad. In one or more embodiments, input devices 190 are portable devices that can direct display or instantiation of applications running on processor 110.

These and other input devices 190 can be connected to processor 110 through a user input interface that is coupled to a system bus 192, but may be connected by other interface and bus structures, such as a parallel port, game port or a universal serial bus (USB). Computers such as computer 100 may also include other peripheral output devices such as speakers and/or display devices, which may be connected through an output peripheral interface 194 and the like.

Computer 100 also includes a radio 198 (containing a transmitter and receiver) for wirelessly transmitting and receiving data for the computer 100 with the aid of an antenna. Radio 198 may wirelessly transmit and receive data using WiMAX™, 802.11a/b/g/n, Bluetooth™, 2G, 2.5G, 3G, and 4G, wireless standards.

Computer 100 may operate in a networked environment using logical connections to one or more remote computers, such as a remote computer. The remote computer may be a personal computer, a server, a router, a network PC, a peer device or other common network node, and may include many if not all of the elements described above relative to computer 100. Networking environments are commonplace in offices, enterprise-wide computer networks, intranets and the Internet. For example, computer 100 may comprise the source machine from which data is being migrated, and the remote computer may comprise the destination machine or vice-versa. Note, however, that source and destination machines need not be connected by a network or any other means, but instead, data may be migrated via any media capable of being written by the source platform and read by the destination platform or platforms. When used in a LAN or WLAN networking environment, computer 100 is connected to the LAN through a network interface 196 or an adapter. When used in a WAN networking environment, computer 100 typically includes a modem or other means for establishing communications over the WAN to environments such as the Internet. It will be appreciated that other means of establishing a communications link between the computers may be used.

According to one embodiment, computer 100 is connected in a networking environment such that processor 110 can process incoming and outgoing data, such as multimedia data, multimedia streams, multimedia content such as video content, audio and/or video content; and any type of image data, streams of images, and image content such as digital still pictures, and the like. The incoming and outgoing data can be to and/or from a portable device or from another data source, such as a remote device 200 and a local device 300.

With reference to FIG. 2, illustrated is an exemplary representation of a remote device 200 in a remote location 210. Remote device 200 includes portable devices such as portable computer systems, capable of interacting with one or more other computer systems. Portable devices may include telephones, wireless telephones 212, cellular telephones, tablet computers, personal digital assistants, computer terminals and/or any other devices that are capable of sending and receiving data. Remote device 200 is shown including a display 214 for displaying content such as images or video, a user input device 216 for allowing a user to input data, an antenna 218 connected with a radio 220, a camera 222 for capturing images or video. Remote device 200 communicates with a network controller 224 through radio 220. Network controller 224 can optionally be disposed within remote device 200.

Network controller 224 is connected to network 226. Network controller 224 may be located at a base station, a service center, or any other location on network 226. Network 226 may include any type of network that is capable of sending and receiving communication signals, including signals for multimedia content, images, data and streaming video.

Network 226 may include a data network, such as the Internet, an intranet, a local area network (LAN), a wide area network (WAN), a cable network, and other like systems that are capable of transmitting multimedia video, streaming video, audio and the like. Network 226 may also include a telecommunications network, such as a local telephone network, long distance telephone network, cellular telephone network, satellite communications network, cable television network and other like communications systems that interact with computer systems to enable set-top boxes or other audio/visual controllers to communicate media and multimedia signals. Network 226 may include more than one network and may include a plurality of different types of networks. Thus, network 226 may include a plurality of data networks, a plurality of telecommunications networks, cable systems, satellite systems and/or a combination of data and telecommunications networks and other like communication systems.

Network 226 is connected with local device 300. Local device 300 includes portable devices such as portable computer systems, capable of interacting with one or more other computer systems. Portable devices may include telephones, wireless telephones 212, cellular telephones, tablet computers, personal digital assistants, computer terminals and/or any other devices that are capable of sending and receiving data. Local device 300 also includes non-portable devices, such as desktop computers 312, set-top boxes, and home audio/video equipment. Local device 300 is shown in FIG. 4 including a display 314 for display images or video, a user input device 316 for inputting data from a user, and a desktop computer 312 connected in a networking environment such that a processor within local device 300 can process incoming and outgoing data, such as multimedia data, multimedia streams, multimedia content such as video content and the like from remote device 200.

In operation, the remote device 200 captures and sends limited bandwidth content 230 from a remote location 210 to the local device 300. The limited bandwidth content 230 is any content which can be sent from the remote device 200, and typically includes content which is optimized for being sent at a limited bandwidth, that is a bandwidth which is less than the bandwidth at which local device 300 can receive content. The limited bandwidth content 230 includes various types of content and data, including image data such as multimedia data, multimedia streams, multimedia content such as video content, audio and/or video content such as frames of video; and any type of still image data, streams of still images, single frames of video, and the like.

Higher bandwidth communication is available to a user in a fixed location compared to a remote user operating in outdoor or indoor locations where the user relies upon long distance wireless networks or local free network access such as WiFi or other 802.11 variants. For example, currently a user operating a laptop or desktop computer will typically have 100 Mbps bandwidth through a wired LAN connection, and this will increase to 1 Gbps with the introduction of TCP/IPv6. In contrast, a remote user operating a mobile phone or PDA will have less than 1 Mbps bandwidth using 3G wireless access, or 1/100th to 1/1000th of the bandwidth of the local user. If the remote mobile user is in range of a WiFi router and has a WiFi-capable handheld device, this may increase to 10 Mbps bandwidth, but this is still 1/10th to 1/100th of the bandwidth of the local user. Even if the local user has only wireless access, the available bandwidth will typically be wider due to proximity to the router and the utilization of advanced technologies such as 802.11n with MIMO (multiple input multiple output), which provides about 40 Mbps.

Bandwidth available to mobile users is expected to increase significantly in the future, but the asymmetry with fixed, local access is expected to persist. WiMAX (802.16) will offer higher bandwidths than legacy wireless systems, but bandwidth is inversely related to distance from the base and is diminished when buildings and other obstacles stand in the path. In urban environments, about 2 Mbps are expected at 10 km. Meanwhile, the fixed, local user is expected to have access to very high bandwidths through optical fiber. Generally, therefore, the local user with a fixed computing platform is expected to have available at least four times, and in many cases at least ten times, the bandwidth as the mobile, remote user.

The limited bandwidth content 230 includes, for example, image data for recreating a limited image 240, or a stream of limited images 240. The limited image 240 comprises a smaller portion 234 of an entire scene 228 which is viewable at the remote location 210. For example, the limited image 240 is a digital still image or photograph, however, the limited image 240 may also be a frame of video. In one embodiment, the limited image 240 has a lower resolution than an enhanced image 242, which is discussed in more detail herein. The limited image 240 is captured at the remote location 210 using camera 222. As used herein, images, such as limited images 240 or enhanced images 242, are equivalent to single frames of video or single still images.

Upon capturing the limited bandwidth content 230, the limited bandwidth content 230 is sent at a limited data rate, or limited bandwidth, from the remote device 200 to the network 226, e.g., through network controller 224. The limited data rate, or limited bandwidth, may be less than the bandwidth or data rate at which local device 300 can receive data. The bandwidth may be limited by the remote device 200 or network 226, according to preferences established by the user of the remote device 200 or priorities of the network 226 (e.g., the limited bandwidth content 230 having a lower priority and thus less bandwidth than network traffic between emergency service providers). Upon capture, the limited image 240 is provided as limited bandwidth content 230 to radio 220, as each limited image 240 is captured, and then the radio 220 transmits the limited bandwidth content 230 to the network controller 224. The manner of image capture, translation into a usable format for transmission and display, and transmission are well known in the art and will only briefly be described. In one embodiment, the limited bandwidth content 230 is streamed to the network 226. The terms streaming information, streaming, or streamed, which are all used interchangeably herein, are conventionally used herein as sending one limited image 240 after another limited image 240 to the network 226. Streaming includes sending information for a series of still images or frames of video. Streaming may be conducted in real time or as set by the network 226 (as long as sufficient memory is present in the remote device 200 to store all of the content to be streamed). Rather than being streamed in real time, streaming may be conducted within a set amount of time, such as within several minutes to several seconds, of when the limited image 240 was captured. In one embodiment, the limited bandwidth content 230 is wirelessly streamed to the network 226 using radio 220.

Upon sending the limited bandwidth content 230 to the network 226, the limited bandwidth content 230 is then received at the local device 300. Local device 300 retrieves enhanced content 232 either before or after receiving the limited bandwidth content 230. If enhanced content 232 is retrieved before the limited bandwidth content 230 is received, it may be retrieved in response to a message from the remote device 200 that arrival of limited bandwidth content 230 is imminent, a particular predetermined time, a user input or any other system stimulus. The enhanced content 232 is any content which can be received by or inputted to the local device 300, and typically includes content which is optimized for being sent at a high bandwidth, that is a bandwidth which is greater than the bandwidth at which remote device 200 can transmit limited bandwidth content 230.

The enhanced content 232 may be retrieved from the network 226, from remote servers, or locally from drives connected with the local device 300. The enhanced content 232 includes various types of content and data, including image data such as multimedia data, multimedia streams, multimedia content such as video content, audio and/or video content such as frames of video; and any type of still image data, streams of still images, single frames of video, and the like. To be transmitted in the same amount of time, the enhanced content 232 uses a substantially larger amount of bandwidth than the limited bandwidth content 230. In various examples, the transmission would employ at least 50% more, and more likely 2 or more times the bandwidth used to transmit the limited bandwidth content 230. Alternatively, transmitted using the same bandwidth, the enhanced content 232 would take a substantially longer amount of time than the limited bandwidth content 230.

The enhanced content 232 may include image data for recreating an enhanced image 242, or a stream of enhanced images 242. The enhanced image 242 comprises a larger portion 236 of an entire scene 228 which is viewable at the remote location 210. Larger portion 236 comprises more of scene 228 than smaller portion 234. The enhanced image 242 may be a digital still image or photograph, or may be a frame of video. In one embodiment, the enhanced image 242 has a higher resolution than the limited image 240, although this need not be the case. In such an embodiment, the enhanced image 242 is captured at the remote location 210, or at a location which appears to look similar to the remote location 210, e.g., using a camera with higher resolution than camera 222, and/or using a data transfer mechanism that allows a higher resolution image to be provided to the local user. For example, the limited image 240 may have a resolution of 176×144 pixels, and the enhanced image 242 may have a resolution of 1280×1024 pixels. In an alternative embodiment, the enhanced image 242 is a computer graphics rendering of the remote location 210, such as can be generated by techniques known to those skilled in the art from computer aided design (CAD) databases of architectural or engineering constructions. Upon capture, the enhanced image 242 is then stored in the network 226 or a drive connected with the local device 300 for later retrieval. The enhanced image 242 may be captured before the limited image 240, and as a result may comprise objects 244 which are older than objects 246 found currently within the scene 228 at the remote location 210.

The enhanced image 242 may be formed from a plurality of still images such as still images which are seamlessly stitched together presenting a panoramic image to the user. In one embodiment, the enhanced image 242 includes a series of stitched still images which are retrieved by the local device 300 in real-time, preferably from the network 226. The series of stitched still images allow a user to have a more interactive experience in which the user can zoom into and out of the stitched still images, and in which the user can adjust his viewing angle of the stitched still images by virtually moving forward, backward, left and right, through the stitched still images.

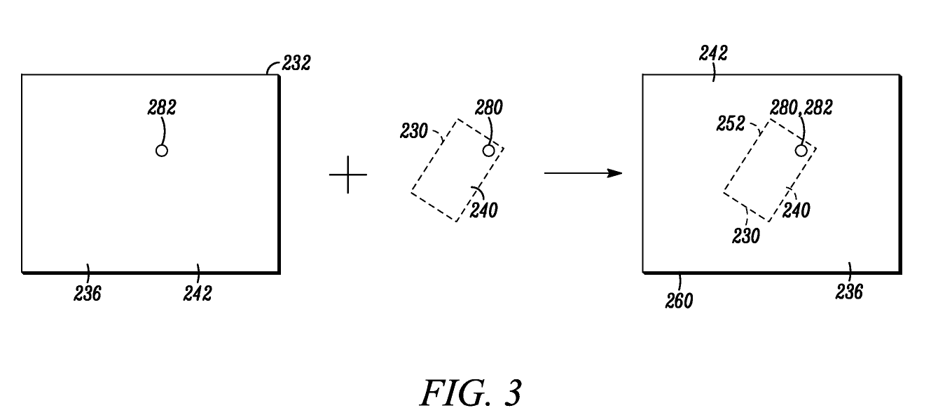

With reference to FIG. 3, upon retrieving the enhanced content 232 and receiving the limited bandwidth content 230, local device 300 then assembles a combined image 260, which has portions of the limited image 240 overlaid on the enhanced image 242. For example, the limited bandwidth content 230 is dynamically combined with the enhanced content 232, so that multiple images or frames of video from the limited bandwidth content 230 are continuously and dynamically superimposed onto the enhanced content 232, replacing a similar image area in the enhanced content 232. When forming the combined image 260, the limited bandwidth content 230 (e.g. the limited image 240) is superimposed onto the enhanced content 232 (e.g., the enhanced image 242). As a result, at least a portion 252 of the combined image 260 provides the user with a more current and possibly more detailed view of the scene 228, using the limited bandwidth content 230. Additionally, a remaining portion 254 of the combined image 260 provides the user with more information about the scene 228 than can be provided by just the limited bandwidth content 230, provides a larger context for the limited image 240, and helps eliminate the keyhole viewing problem associated with displaying just the limited bandwidth content 230.

In one embodiment, the limited bandwidth content 230, and each limited image 240, represent a subset of information which is being represented by the enhanced content 232, and each enhanced image 242. Each limited image 240 comprises a smaller portion 234 of the scene 228, while each enhanced image 242 comprises a larger portion 236 of the scene 228, wherein the larger portion 236 comprises more of the scene 228 than the smaller portion 234. For example, as shown in FIG. 2, the limited bandwidth content 230 may represent a limited image 240 taken at the remote location 210. The limited image 240 comprises a smaller portion 234 of the scene 228 at the remote location 210. The enhanced image 242 comprises a larger portion 236 of the scene 228 at the remote location 210.

In this way, the enhanced image 242 provides a larger context for each limited image 240 being streamed from the remote device 200 to the local device 300. Furthermore, since the enhanced image 242 comprises more of the scene 228 than the limited image 240, the combined image 260 is able to present the user with a view of the scene 228 which is more appropriate for the size and resolution of the screen 314 of the local device 300. Additionally, since the data rate at which the limited bandwidth content 230 is being streamed is less than a data rate at which enhanced images 242 would be streamed, by combining the limited image 240 with the enhanced image 242, a user can be provided with an improved experience over just viewing the limited image 240 alone without having to increase the data rate at which limited bandwidth content 230 is being sent or streamed (if such an increase is even possible).

The limited bandwidth content 230 may comprise at least a single frame of video, and the enhanced content 232 may comprise a still image which encompasses at least one visual cue found in the single frame of video. For example, when local device 300 assembles the combined image 260, the limited image 240 is aligned with the enhanced image 242. Aligning the limited image 240 to the enhanced image 242 can be accomplished using stitching software which is widely available, such as that described in US 2007/0237420, US 2008/0028341, and the Photosynth™ family of applications from Microsoft™ Corporation of Redmond, Wash. Aligning the limited image 240 to the enhanced image 242 may include scaling, rotating and transforming the limited image 240 so that the limited image 240 is blended into the enhanced image 242, with as few perceptible seams as possible. In one embodiment, first and second visual cues 280, 282 which are found in the limited image 240 and the enhanced image 242, respectively, are used to align the limited image 240 to the enhanced image 242. First and second visual cues 280, 282 represent the same object. Aligning the limited image 240 to the enhanced image 242 would then include aligning first and second visual cues 280, 282 with each other. Additionally, more than one visual cue may be found in each of the limited image 240 and the enhanced image 242 and used to align the limited image 240 to the enhanced image 242. By aligning the limited image 240 to the enhanced image 242, the limited image 240 is able to blend into the enhanced image 242, to provide the user with a more seamless image. Additionally, if multiple limited images 240 are streamed to the network 226 and received by local device 300, by aligning each of the multiple limited images 240, a video sequence formed by the multiple limited images 240 can appear to be effectively stabilized within the enhanced image 242. As a result, the user is provided with an image that appears to have less jitter than when viewing the multiple limited images 240 alone. Since camera 222 focuses on the subject 280, who may be moving and whose movements may be tracked by the camera 222, the limited image 240 is often jittery and unstable. By aligning the multiple limited images 240 within the enhanced image 242, which is stable and relatively free of jitter, the combined image 260 which is presented appears more stable and less jittery.

In one embodiment, the limited bandwidth content 230 includes location data such as global position system (GPS) data or cellular telephone triangulation position data, which provide the general location of the remote device 200 at the time the limited image 240 is captured. In another embodiment, the limited bandwidth content 230 includes accelerometer data, which provides the general direction in which the remote device 200 is being moved and/or orientation of the remote device 200 at the time the limited image 240 is captured. By using location data and/or accelerometer data, the enhanced image 242 may be appropriately selected from a location-indexed database of images such as Google™ StreetView™ or EveryScape™, limited image 240 may be more accurately aligned to the enhanced image 242, and enhanced image 242 may be dynamically adjusted to keep the limited image 240 in frame as remote device 200 is moved or redirected.

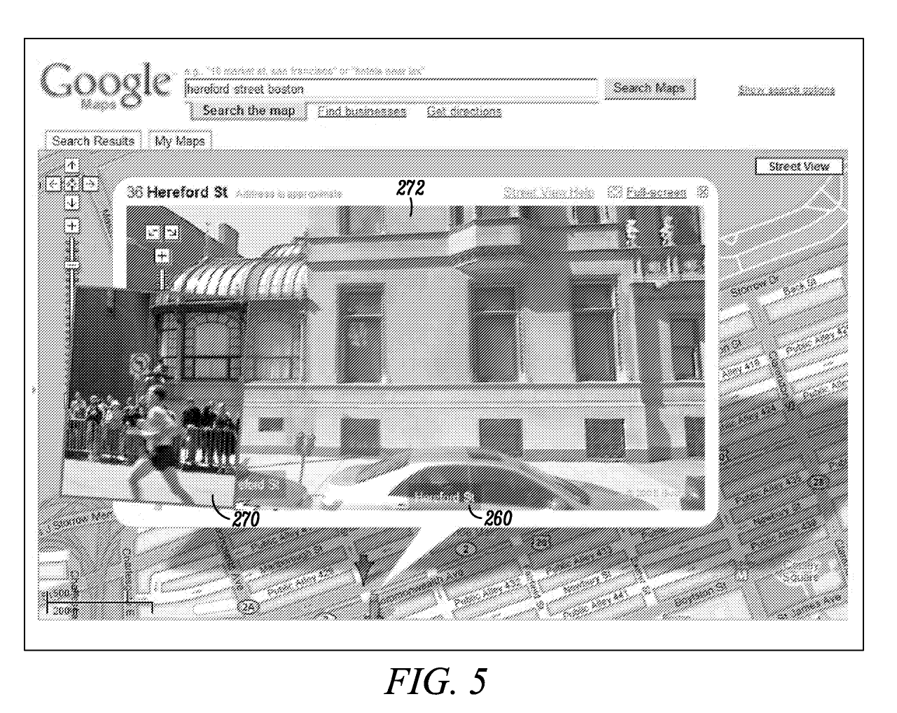

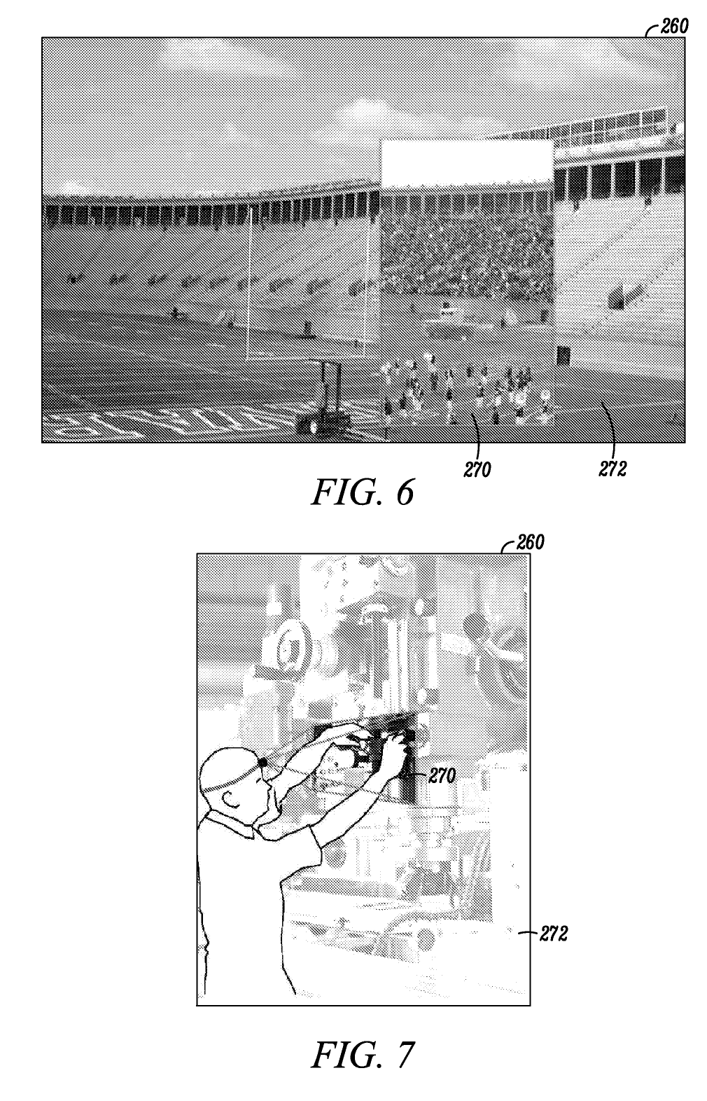

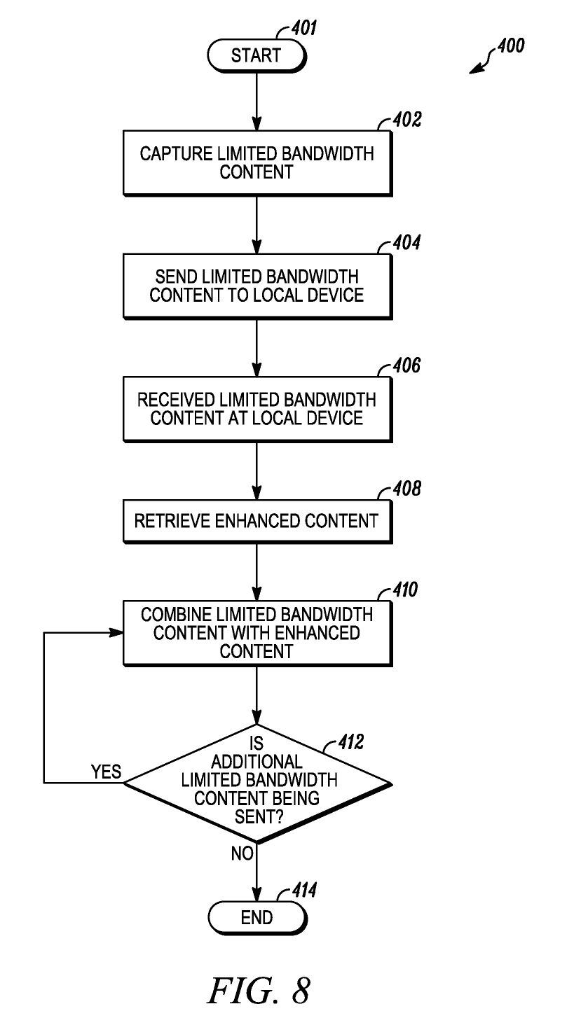

With reference to the examples provided in FIGS. 5, 6, and 7, the limited bandwidth content 230 comprises multiple frames of video 270 and the enhanced content 232 comprises a still image 272. In this embodiment, each frame of video 270 is aligned to the still image 272 represented by the enhanced content 232, frame by frame, whereby only one frame of video 270 is viewable at a time. In this manner, the multiple frames of video 270 would appear blended within the enhanced image 242. With reference to FIG. 5, in one embodiment, the frames of video 270 capture an object which moves across the scene 228, and as a result, appear to move across the still image 272. More specifically, the image in FIG. 5 shows a map overlaid with a still image of a street scene (enhanced content) in which a video frame of runner in a race (limited bandwidth content 230) has replaced a portion of the street scene and has provided additional material to extend the street scene. Thus, as shown the combined content may include images that are larger than that of the enhanced content. In addition, as shown although some features of the still image are permanent (e.g., street, building) and differ from the video frame due to lighting or other ambient conditions, other temporary features (e.g., people, barricade) may be present only in one of the still image or video frame. This latter effect creates a natural demarcation between the two without any additional boundary being used. With reference to FIGS. 6 and 7, in one embodiment, the frames of video 270 capture an object or portion of the scene which is stationary, and instead the video 270 is panned across the scene, providing the user with a new and updated view of different portions of the scene 228. The same effects as that above are present in the image shown in FIG. 6—the still image is that of a permanent structure (an empty stadium) and the video frame contains temporary features (crowd in the stands, players or band on the field).

In addition to entertainment purposes, however, this technique may be employed as a learning or diagnostic tool. This usage is shown in FIG. 7, in which the combined content of the overall machinery (enhanced content 260) and specific settings being adjusted by an operator is presented to a technician more skilled or knowledgeable about the machinery but remote from the machinery. The operator (shown in FIG. 7 as wearing a headpiece containing the camera) works on a portion of the machinery (limited bandwidth content 270) while the remote technician audibly communicates with the operator through an earpiece or other communication device. So that the remote technician has the current settings of the machinery, the machinery can first be scanned by the operator using the camera before attempting the adjustment. The computer at the location of the remote technician, which has access to a static image of the machinery, in one mode updates the stored static image with the limited bandwidth content image (or at least the changes between the two images) for storage and later retrieval. In another mode, the stored static image is updated with the limited bandwidth content image only temporarily (e.g., while the session is active or for a limited amount of time thereafter in case of temporary, undesired disconnection). In a further mode, the stored static image is not updated with the limited bandwidth content image, with the portion of the combined content image reverting to the corresponding portion of the original stored static image when the limited bandwidth content image is moved from the location of the portion. In any case, the remote technician can thus see and guide the operator in real time using the combined content, which is presented on a display at location of the remote technician.

FIG. 8 provides a method 400 for presenting content from a remote device. At block 401, the method is initiated with a start operation. At block 402, the remote device 200 captures limited bandwidth content 230 in the form of limited image 240 from scene 228 at remote location 210. Upon capturing the limited bandwidth content 230, the remote device 200 then sends the limited bandwidth content 230 to local device 300 through network 226, at block 404. Upon sending the limited bandwidth content 230 to the local device 300, the limited bandwidth content 230 is received at the local device 300 at block 406. Then, at block 408, the local device 300 retrieves enhanced content 232. At block 410, the local device 300 combines the limited bandwidth content 230 with the enhanced content 232 retrieved by the local device 300. Upon combining the limited bandwidth content 230 with the enhanced content 232, method 400 determines if additional limited bandwidth content 230 is being sent at block 412. If additional limited bandwidth content 230 is being sent to the local device 300, then the method 400 goes back to block 410 and combines the limited bandwidth content 230 with the enhanced content 232 retrieved by the local device 300. If additional limited bandwidth content 230 is not being sent to the local device 300, then the method 400 goes to block 414 and ends.

The telecommunications industry is anticipating video streaming applications, some of which have been shown and described. Among the most commonly depicted uses is experience sharing from a sports or entertainment venue. In this scenario, a mobile device user is at a sports event (e.g., a baseball game) or music event (e.g., a rock concert), and wants to send video to a friend who is at home. The friend at home (the local user) receiving the video stream and viewing it on the local laptop screen will see a small (or poor resolution if enlarged), jittery video with limited context (keyhole viewing). Using the above embodiments enables the local user to improve the viewing experience by stitching the streamed video into a panoramic still photograph of the ballpark or stadium. This provides context for the streamed video, eliminates jitter by stabilizing the video subjects within the panorama, and presents the local user with a visual experience more appropriate for the local screen (which is larger than the image taken at the remote site).

As above, the live video and database panorama may not be well-matched in terms of the ambient/environmental conditions such as the time of day, weather, or traffic. In fact, contrast between the two will make the live feed more vivid as shown in the examples provided in FIGS. 5 and 6. For example, a live halftime show video stitched into a panorama of the empty stadium of FIG. 6 makes the color and action of the video more striking. The empty stadium provides context without conflicting or distracting content.

Another example use is one in which a remote user is on the street and seeking navigation or information assistance from a local user who has the benefits of a full-size keyboard, large display screen, and high speed internet connection. By streaming video from his handheld device to the local user, the remote user can easily present a vivid and content-rich illustration of his present circumstances. The invention allows the local user to stitch the streamed video into a panorama of the street scene available from an internet service such as EveryScape™ or Google™ StreetView™. Here again the invention eliminates video jitter by stabilizing the streamed video within the panorama—the frame still moves about within the panorama as the remote user's hand moves, but the local user is spared the “seasickness” effect of watching handheld video because his overall view is stable. Also, the local user sees the streamed video “keyhole view” in the context of the larger setting, and this larger setting facilitates the local user's rapid understanding of the remote user's location, direction, and navigation options.

Another example use is in field service as described above in relation to FIG. 7. A single master technician could address a dozen field repairs or training sessions simultaneously, providing live coaching to junior technicians in the field via different images displayed on the display local to the master technician. Stitching the junior technician's video feed into a database image of the equipment would provide instant orientation, eliminate the same jitter problems of a consumer video experience, and facilitate intuitive direction.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation. Those having skill in the art will recognize that examples of such comprehensive devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Quest, Southwestern Bell, etc.); or (g) a wired/wireless services entity such as Sprint, Cingular, Nextel, etc.), etc.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. Accordingly, the invention is not to be restricted except in light of the appended claims and their equivalents.

1. A method of presenting content from a remote device, the method comprising:
receiving limited bandwidth content from a remote device at a local device; and
superimposing the limited bandwidth content on enhanced content retrieved by the local device, wherein the limited bandwidth content comprises a subset of what is represented by the enhanced content.

2. The method of claim 1, wherein the limited bandwidth content is a single frame of video, and wherein the enhanced content is a still image which encompasses at least one visual cue found in the single frame of video.

3. The method of claim 1, wherein the limited bandwidth content includes a first visual cue, wherein the first visual cue is encompassed by the enhanced content.

4. The method of claim 1, wherein the limited bandwidth content includes a first visual cue, wherein the enhanced content includes a second visual cue which comprises the first visual cue, and wherein the superimposing includes aligning the limited bandwidth content to the enhanced content, so that the first visual cue is aligned with the second visual cue.

5. The method of claim 4, wherein the aligning includes at least one of rotating, stretching, and transforming the limited bandwidth content so that the limited bandwidth content is superimposed on the enhanced content.

6. The method of claim 1, wherein the limited bandwidth content includes multiple frames of video and the enhanced content includes a still image, and wherein the superimposing includes stitching each frame of video to the still image, frame by frame.

7. A method of presenting content from a remote device, the method comprising:
receiving streaming limited bandwidth content captured at a remote location by a remote device at a local device;
aligning the limited bandwidth content with enhanced content retrieved by the local device, wherein the limited bandwidth content comprises a subset of what is represented by the enhanced content, wherein the limited bandwidth content includes a first visual cue, wherein the enhance visual content includes a second visual cue, wherein the first and second visual cues represent the same object, and wherein the first and second visual cues are aligned with each other.

8. The method of claim 7, wherein the limited bandwidth content contains multiple frames of video, and wherein the enhanced content is a still image which encompasses a third visual cue found in the multiple frames of video.

9. The method of claim 7, wherein the limited bandwidth content is streamed at a bandwidth which is less than the bandwidth at which the enhanced content is retrieved.

10. The method of claim 7, wherein the limited bandwidth content comprises a smaller portion of an entire scene which is viewable at the remote location, wherein the enhanced content comprises a larger portion of the scene which is viewable at the remote location, and wherein the larger portion comprises more of the scene than the smaller portion.

11. The method of claim 10, wherein the limited bandwidth content is a streaming video and the enhanced content is formed from still images which are stitched together to form a panoramic image.

12. The method of claim 7, wherein the aligning includes at least one of rotating, stretching, and transforming the limited bandwidth content so that the limited bandwidth content is superimposed on the enhanced content.

13. The method of claim 7, wherein the limited bandwidth content includes location data.

14. A method of presenting content, the method comprising:
receiving at a local device limited bandwidth content streamed from a remote device;
retrieving at the local device enhanced content; and
forming a combined image having the limited bandwidth content continuously superimposed on the enhanced content, wherein the limited bandwidth content comprises a subset of what is represented by the enhanced content.

15. The method of claim 14, wherein the limited bandwidth content contains multiple frames of video, and wherein the enhanced content is a still image which encompasses at least one visual cue found in the multiple frames of video.

16. The method of claim 14, wherein the limited bandwidth content is streamed at a bandwidth which is less than the bandwidth at which the enhanced content is retrieved.

17. The method of claim 14, wherein the limited bandwidth content comprises a smaller portion of an entire scene which is viewable at the remote location, wherein the enhanced content comprises a larger portion of the scene which is viewable at the remote location, and wherein the larger portion comprises more of the scene than the smaller portion.

18. The method of claim 17, wherein the limited bandwidth content is a streaming video and the enhanced content is formed from still images which are stitched together to form a panoramic image.

19. The method of claim 14, wherein the forming of the combined image includes at least one of rotating, stretching, and transforming the limited bandwidth content so that the limited bandwidth content is superimposed on the enhanced content.

20. The method of claim 14, wherein the limited bandwidth content includes location data.
